(19) United States
(12) Patent Application Publication
(10) Pub. No.: US 2015/0120332 A1
(43) Pub. Date: Apr. 30, 2015

(54) SYSTEMS AND METHODS FOR DETERMINING RISK EXPOSURE

(71) Applicant: AON BENFIELD, INC., Chicago, IL (US)

(72) Inventors: STEPHEN JOHN MARTIN MILDENHALL, OAK PARK, IL (US); KIRK WILLIAM DYBVIK, CHASKA, MN (US)

(73) Assignee: AON BENFIELD, INC., Chicago, IL (US)

(21) Appl. No.: 14/062,277

(22) Filed: Oct. 24, 2013

(51) Int. Cl. G06Q 40/08

(52) U.S. Cl. CPC G06Q 40/08
USPC 705/4

(57) ABSTRACT

Systems and methods of the present technology provide the capability to determine risk exposure of points of interest (e.g., insured locations) based on the occurrence of an event (e.g., a catastrophic event). The systems and methods use two-dimensional convolution and FFT processing to provide quick determinations.

### FIELD OF THE INVENTION

The present technology relates to systems and methods for determining risk exposure of points of interest such as e.g., insured locations based on the occurrence of an event (e.g., a catastrophic event).

### DESCRIPTION OF RELATED ART

It is known that models or other computer applications may be used to assess the potential liabilities of catastrophic events. These events may be either man-made (e.g., terrorist attack) or naturally occurring disasters such as e.g., earthquakes, tornados, and hurricanes.

Certain companies, such as insurance companies, may find information provided by these models/applications useful in determining their potential liability (i.e., risk exposure) based on the occurrence of the event. These models/applications use, generate and store large amounts of data that need to be processed and analyzed to facilitate the determination of its potential liabilities based on the event. The existing methods are also time consuming. As such, there is a need and desire for a better system and method for determining risk exposure of e.g., insured locations based on the occurrence of an event such as a catastrophic event.

### BRIEF DESCRIPTION OF THE DRAWINGS

Specific examples have been chosen for purposes of illustration and description, and are shown in the accompanying drawings, forming a part of the specification.

FIG. 1 illustrates one example of a computing device system of the present technology.

FIG. 2 illustrates one example of points of interest illustrated with an overlying grid.

FIG. 3 illustrates one example of a grid with cells containing exposure summations based on the points of interest illustrated in FIG. 2.

FIG. 4 illustrates an example event footprint superimposed over a footprint grid.

FIG. 5 illustrates an example of shape coverage factors for the cells within the footprint grid illustrated in FIG. 4.

FIG. 6 illustrates an example data grid having an apron comprising kernel padding cells around the insured location grid of FIG. 3, and example anchoring techniques for a kernel.

FIG. 7 illustrates an example grid having cells filled with convolution results.

### DETAILED DESCRIPTION

The technology disclosed herein provides the capability to determine risk exposure or other statistical or characteristics of “points of interest” (e.g., insured locations) when the points of interest have been exposed to an event such as e.g., a catastrophic event that triggers insurance coverage. One existing application for determining risk exposure places a given set of insured locations on a map and creates a spatial “footprint” of the event. The footprint has a certain shape (i.e., polygon) and size based on the event. The application then uses the footprint and the map to determine the insured locations with the largest amount of exposure (i.e., locations covered by the footprint having the most liability for the insurance carrier).

The application associates a grid of cells with the map of insured risks, and partitions the insured locations into different grid cells. The grid cells are set to a specified width and height based on latitude and longitude, and the insured locations within each of the cells are identified. The spatial footprint of the event is also partitioned into a grid having the same resolution as the map's grid. Using a process based on an SQL database, the intersection of the spatial footprint grid cells and the insured locations' grid cells is calculated. The spatial footprint is moved across the grid of insured locations and anchored at various locations along the map grid. Exposure of map grid cells covered by the spatial footprint is then calculated. By comparing the aggregations from each anchor point, one could identify the anchor points where the exposure was at its highest values. It should be appreciated that the principles disclosed herein can do more than identifying the highest exposure values; for example, the disclosed principles provide the ability to identify the whole range of exposure values (e.g., all anchor points greater than one billion dollars, two billion dollars, etc.). This whole distribution is then a key factor in determining the exceedance probability (EP) distribution of potential losses.

One major shortcoming of the current approach is that it takes a long time to run its analysis. As can be appreciated, this shortcoming is very undesirable and needs to be addressed.

The inventors have determined that the risk exposure determining process could be performed in a different and much more beneficial manner using a process known as convolution or moving window analysis. As is known in the art, convolution is a processing technique that takes a kernel of coefficients or weights (usually a matrix) and applies it to a set of points (e.g., pixels in an image) to calculate values for each point. The value for a point typically includes multiplying the point and its neighbors with the coefficients/weights in the kernel. The sum of the multiplications are added and stored as that point's value.

In the disclosed convolution risk exposure determination technique, points of interest (e.g., insured locations) are represented by a first grid, referred to herein as the insured location grid for convenience purposes only. In addition, the event footprint will be represented by a second grid, referred to herein as the spatial footprint grid for convenience purposes only. As will become apparent, the grids will be used to create a spatial footprint kernel (discussed below in more detail) that is then used in a moving window analysis to generate values of risk exposure for each insured location within the first grid. A final determination for where the risk exposure is the greatest can be made from the risk exposure values for each location.

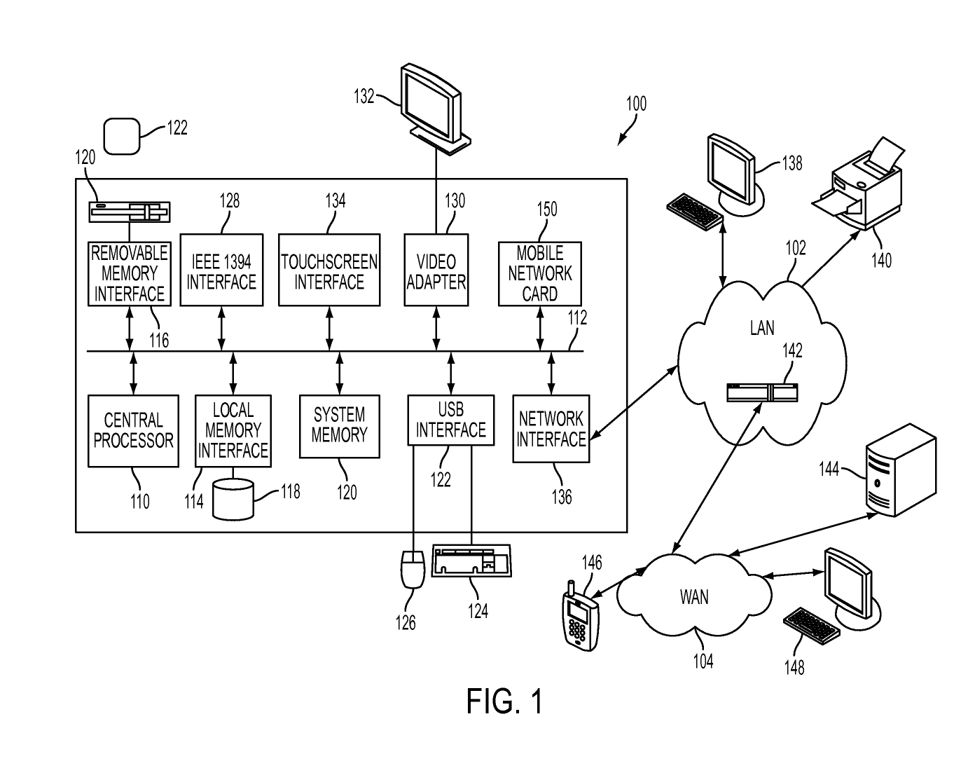

Various examples of the present technology may be implemented with computing device devices, computing device networks and systems that exchange and present information. Elements of an exemplary computing device system are illustrated in FIG. 1, in which the convolution risk exposure determination functionality are provided to a user by a computing device 100. Computing device 100 can be connected to a local area network (LAN) 102 and/or a wide area network (WAN) 104. Computing device 100 can include a central processor 110 that controls the overall operation of the computing device, and a system bus 112 that connects central processor 110 to the components described below. System bus 112 may be implemented with any one of a variety of conventional bus architectures.

Computing device 100 can include a variety of interface units and drives for reading and writing data or files. In particular, computing device 100 can include a local memory interface 114 and a removable memory interface 116 respectively coupling a hard disk drive 118 and a removable memory drive 120 to system bus 112. Examples of removable memory drives include magnetic disk drives and optical disk drives that receive removable memory elements 122. Hard disks generally include one or more read/write heads that convert bits to magnetic pulses when writing to a computing device-readable medium and magnetic pulses to, bits when reading data from the computing device readable medium. A single hard disk drive 118 and a single removable memory drive 120 are shown for illustration purposes only and with the understanding that computing device 100 may include several of such drives. Furthermore, computing device 100 may include drives for interfacing with other types of computing device readable media such as magneto-optical drives.

Unlike hard disks, system memories, such as system memory 120, generally read and write data electronically and do not include read/write heads. System memory 120 may be implemented with a conventional system memory having a read only memory section that stores a basic input/output system (BIOS) and a random access memory (RAM) that stores other data and files.

A user can interact with computing device 100 with a variety of input devices, and through graphical user interfaces provided to the user by the computing device 100, such as though a browser application. For example, FIG. 1 shows a universal serial bus (USB) interface 122 coupling a keyboard 124 and a pointing device 126 to system bus 112. Pointing device 132 may be implemented with a hard-wired or wireless mouse, track ball, pen device, or similar device.

Computing device 100 may include additional interfaces for connecting peripheral devices to system bus 112. FIG. 1 shows a IEEE 1394 interface 128 that may be used to couple additional devices to computing device 100. Peripheral devices may include game pads scanners, printers, and other input and output devices and may be coupled to system bus 112 through parallel ports, game ports, PCI boards or any other interface used to couple peripheral devices to a computing device.

Computing device 100 also includes a video adapter 130 coupling a display device 132 to system bus 112. Display device 132 may include a cathode ray tube (CRT), liquid crystal display (LCD), field emission display (FED), plasma display or any other device that produces an image that is viewable by the user. A touchscreen interface 134 may be included to couple a touchscreen (not shown) to system buss 112. A touchscreen may overlay at least part of the display region of display device 132 and may be implemented with a convention touchscreen technology, such as capacitive or resistive touchscreen technology.

One skilled in the art will appreciate that the device connections shown in FIG. 1 are for illustration purposes only and that several of the peripheral devices could be coupled to system bus 112 via alternative interfaces. For example, a video camera could be connected to IEEE 1394 interface 128 and pointing device 126 could be connected to another interface.

Computing device 100 may include a network interface 136 that couples system bus 112 to LAN 102. LAN 102 may have one or more of the well-known LAN topologies and may use a variety of different protocols, such as Ethernet. Computing device 100 may communicate with other computing devices and devices connected to LAN 102, such as computing device 138 and printer 140. Computing devices and other devices may be connected to LAN 102 via twisted pair wires, coaxial cable, fiber optics or other media. Alternatively, electromagnetic waves, such as radio frequency waves, may be used to connect one or more computing devices or devices to LAN 102.

A wide area network 104, such as the Internet, can also be accessed by computing device 100. FIG. 1 shows network interface 136 connected to LAN 102. LAN 102 may be used to connect to WAN 104. FIG. 1 shows a router 142 that may connect LAN 102 to WAN 104 in a conventional manner. A server 144. Mobile terminal 146 and a computing device 148 are shown connected to WAN 104. Of course, numerous additional servers, computing devices, handheld devices, personal digital assistants, telephones and other devices may also be connected to WAN 104.

In some examples, a mobile network card 150 may be used to connect to LAN 102 and/or WAN 104. Mobile network card may be configured to connect to LAN 102 and/or WAN 104 via a mobile telephone network in a conventional manner.

The operation of computing device 100 and server 144 may be controlled by computing device-executable instructions stored on a non-transient computing device-readable medium. For example, computing device 100 may include computing device-executable instructions stored on a memory for transmitting information to server 144, receiving information from server 144 and displaying the received information on display device 132. Furthermore, server 144 may include stored on a memory computing device-executable instructions for, receiving requests from computing device 100, processing data and transmitting data to computing device 100. In some embodiments server 144 transmits hypertext markup language (HTML) and extensible markup language (XML) formatted data to computing device 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102 and 104, but also a “content network,” which is comprised of the data—attributable to a single entity—which resides across all physical networks.

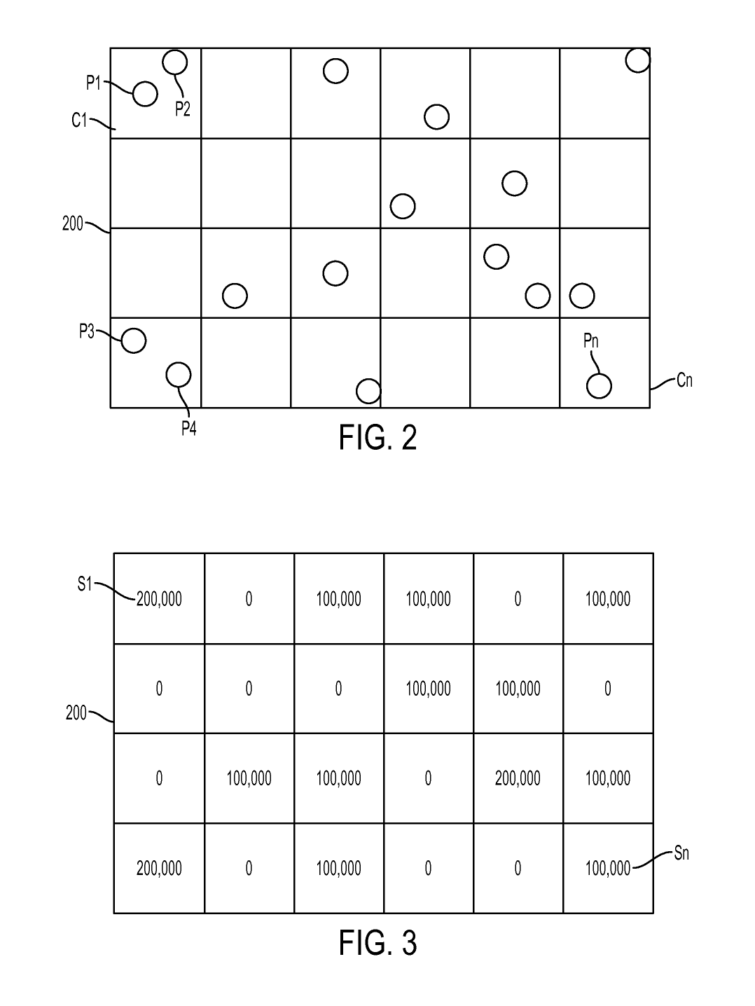

An example of the disclosed convolution risk exposure determination is now described with reference to FIGS. 2-7. FIG. 2 illustrates one example of points of interest P1, P2, Pn illustrated with an overlying grid 200. In the present example, the points of interest P1, P2, . . . Pn are insured locations within a region associated with the grid 200 and each insured location is associated with a particular amount of insurance coverage (i.e., risk exposure). In the illustrated embodiment, each point of interest P1, P2, Pn corresponds to $100,000 of exposure. It should be appreciated that this is an example amount of exposure and that any amount could be used. The grid 200 contains an array of cells C1, . . . , Cn, which can be configured/sized to represent regions of interest (e.g., specific cities, regions on a map, etc.). It is desirable for the grid to be tight enough to capture the exposure distribution on the scale of a tornado. Tornado tracks range in length from less than a mile to over fifty miles and are up to one mile wide. Therefore, in one embodiment, the grid 200 resolution is one mile-by-one mile or smaller. It should be appreciated that the grid 200 can have more or less rows/columns than those illustrated and that the disclosed embodiment is not to be limited to any particular grid size. In one embodiment, the preparation of the insured location grid 200 is done at runtime—rather than beforehand—which allows for the flexibility of filtering the data for various criteria, allows for flexibility of the grid resolution, eliminates the manual process of creating the grid, and eliminates the storage requirements for the grid and any intermediate results. In one embodiment, the grid can be generated at runtime from a SQL database of stored, geocoded locations. By scaling and rounding the geocoded latitude and longitude appropriately, a new grid can be produced very efficiently as a table, which can then be transformed into matrix form.

FIG. 3 illustrates one example of the grid 200 with cells C1, . . . , Cn containing exposure summations S1, . . . , Sn based on the points of interest P1, P2, . . . Pn illustrated in FIG. 2. In the illustrated example, the first cell C1 has a summation S1 of $200,000 based on the summation of the exposures of points P1 and P2. It should be appreciated that the contents of the cells are not limited to summations and could, alternatively or additionally, include other mathematical operations or relationships of the data and/or other statistical data if desired.

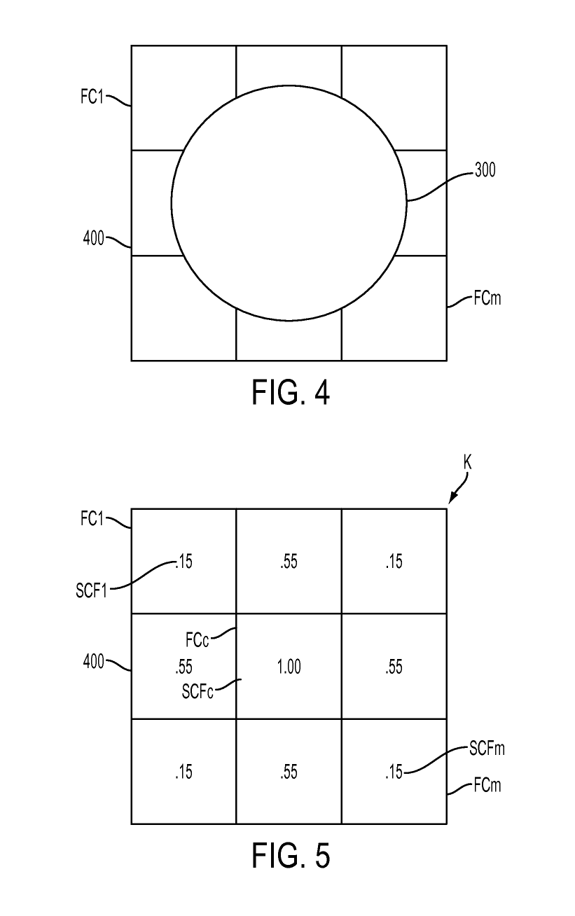

FIG. 4 illustrates an example event footprint 300 superimposed over a footprint grid 400. In the illustrated example, the footprint 300 is shown as being a circle, but it should be appreciated that any shape (e.g., square, rectangle, polygon, etc.) can be used to represent the footprint of the event. Moreover, the footprint could actually be a set of nested polygons, so that a different percentage of the exposed risks located within each polygon could contribute to the aggregate total. The footprint grid 400 comprises an array of footprint cells FC1, . . . , FCm. The footprint cells FC1, . . . , FCm have the same size (i.e., dimensions) as the insured location cells C1, . . . , Cn illustrated in FIGS. 2 and 3. In the illustrated embodiment, the grid 400 comprises a 3×3 array of footprint cells FC1, FCm. It should be appreciated that the footprint grid 400 can have more or less than 3 rows/columns and that the disclosed embodiment is not to be limited to any particular array or array size. As will be discussed below in more detail, the footprint grid 400 will be used as a kernel for the disclosed convolution technique.

The event footprint 300 is then used to determine the ratio/amount of each footprint cell's FC1, FCm area that is covered by the footprint's 300 shape. These ratios are referred to herein as the shape coverage factors. FIG. 5 illustrates an example of shape coverage factors SCF1, . . . , SCFm for the cells FC1, . . . , FCm within the footprint grid 400 illustrated in FIG. 4. As noted above, the footprint grid 400 and its shape coverage factors are used as a kernel K in subsequent convolution processing. As can be seen, the first and last footprint cells FC1, FCm (and others) have a shape coverage factor SCF1, SCFm of 0.15 (i.e., only 15% of their respective areas are covered by the footprint 300) while the center footprint cell FCc has a shape coverage factor SFCc of 1.0 (i.e., 100% of its area is covered by the footprint 300). In one embodiment, the preparation of the footprint grid 400 can be done at runtime (e.g., in a similar manner that grid 200 is created), which allows for the flexibility of selecting shapes from a spatial library without the need to manually process the shape. This also removes the need to store the grid cell coordinates in a database, and also allows for retaining information such as the shape coverage factors SCF1, . . . , SCFm.

Once the two grids 200, 400 are generated, they are formatted in a way to apply convolution processing to complete the risk exposure determination analysis. For example, convolution problems lend themselves nicely to the techniques of discrete Fourier transforms (DFTs). The most common fast convolution algorithms use fast Fourier transform (FFT) algorithms via the circular convolution theorem. That is, the circular convolution of two finite-length sequences is found by taking an FFT of each sequence, multiplying point-wise, and then performing an inverse FFT. An open source project called FFTW (Fastest Fourier Transform in the West—http://fftw.org) is an example of a library of computer applications that can be used for DFT calculations. There are other similar libraries available, a few examples are cufft from NVidia (https://developer.nvidia.com/cufft) and applications in the Intel Math Kernel Library (http://software.intel.com/sites/products/documentation/hpc/mkl/mklman/GUID-BE3BF27D-D852-4C7A-BD38-4409D54E1B1A.htm).

Since the kernel K (i.e., footprint grid 400 containing the shape coverage factors SCF1, . . . , SCFm) will be applied against the insured location grid 200 via e.g., circular convolution, it is desired that padding should be added to the insured location grid 200 to avoid a “wrap around” effect that could adversely impact the convolution results. This padding is referred to herein as an apron and is a function of the dimensions of the kernel/footprint grid's 400 shape.

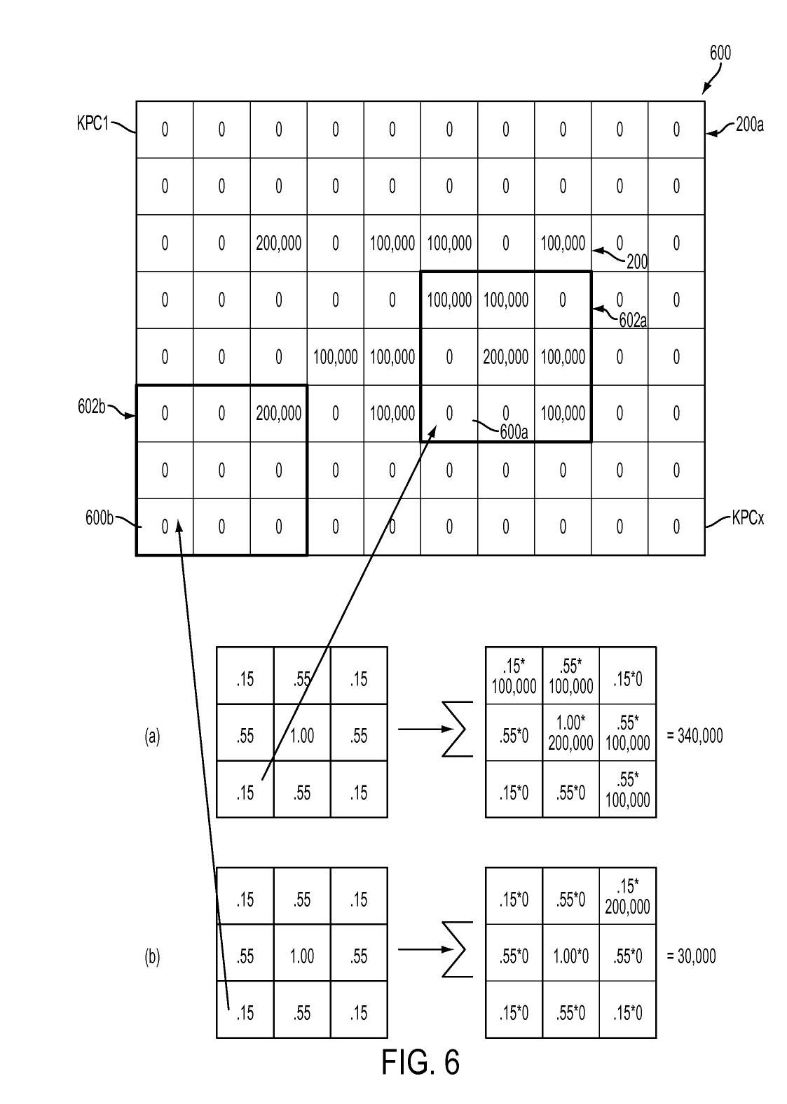

FIG. 6 illustrates an example data grid 600 having an apron 200a comprising kernel padding cells KPC1, . . . , KPCx around the insured location grid 200. FIG. 6 also illustrates example anchoring techniques for a kernel (discussed below in more detail). One of skill in the art will appreciate that since the kernel/footprint grid 400 is a 3×3 matrix, the outside cells (e.g., C1, Cn) of the insured location grid 200 need to be padded by two cells. As such, the grid 600 illustrated in FIG. 6 has an apron comprising two columns to the left of the first column in the insured location grid 200, two columns to the right of the last column in the insured location grid 200, two rows above the first row in the insured location grid 200, and two rows below the last row in the insured location grid 200.

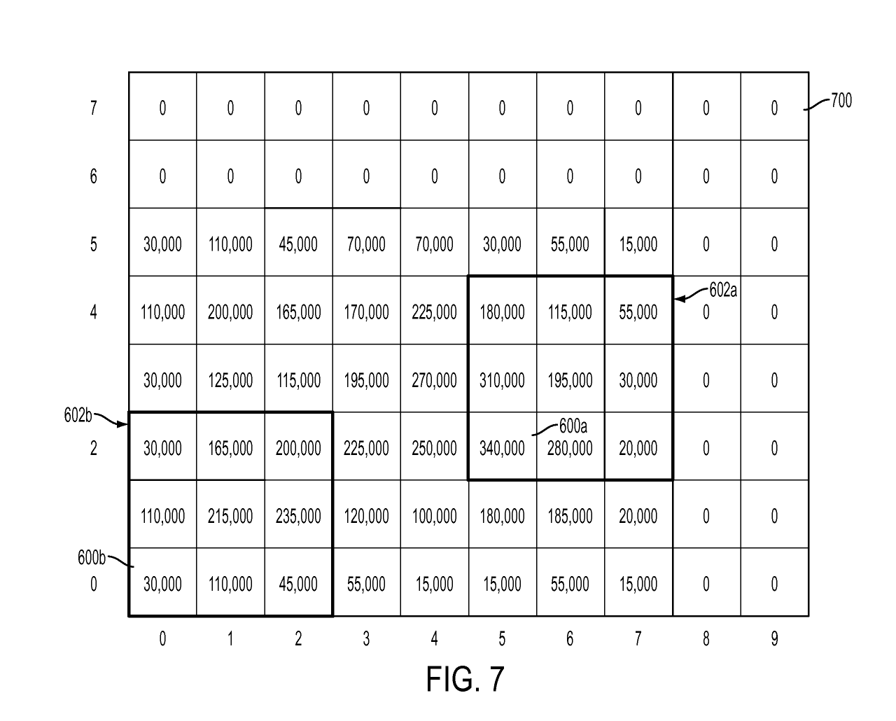

Once the data grid 600 is prepared, convolution processing may begin. Specifically, the kernel K (i.e., footprint grid 400 and its shape coverage factors SCF1, . . . , SCFm) is moved across the grid 600 to provide convolution results to each cell in the manner described below. In one embodiment, the bottom left cell in the kernel K is anchored to a cell within the grid 600. The kernel's K shape coverage factors SCF1, . . . , SCFm are then multiplied with the summations in the grid 600 cells covered by the kernel (it should be appreciated that the summations for apron cells is 0). All of these values (i.e., products) are then added together and that sum (i.e., the convolution result) is associated with the cell the kernel K is anchored to. For example, in situation (a), the kernel K is anchored at cell 600a and multiplied with the summations in the cells within area 602a, and the products are added to achieve a convolution result for cell 600a (shown in FIG. 7). In situation (b), for example, the kernel K is anchored at cell 600b and multiplied with the summations in the cells within area 602b, and the products are added to achieve a convolution result for cell 600b. As noted above, it is desirable to implement this processing using DFFTs or FFTs with the grid 600 and kernel K as inputs. One of skill in the art would understand how to implement the convolution processing with DFTs or FFTs. The process is performed for each cell in the grid 600 (i.e., each cell is an anchoring point and obtains a convolution result by applying the kernel K to the appropriate cells).

FIG. 7 illustrates an example grid 700 with convolution results within its cells. As can be seen, the result in cell 600a is $340,000 (based on the calculations within area 602a) and the result in cell 600b is $30,000 (based on the calculations within area 602b). From these results, a determination of the highest risk exposure can be made.

It should be appreciated that the present technology can be applied to more complex insurance policy structures such as those used by commercial insurance policies. The present technology can be adapted to handle more complex shapes that represent catastrophes or other events. It should be appreciated that the present technology may apply to a multitude of shapes (perhaps hundreds or thousands) through the application against the same portfolio of insured locations, if desired.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A method of determining risk exposure associated with points of interest, said method comprising the steps of:
generating, by a computing device, a first grid comprising cells with exposure totals for points of interest within the cells;
generating, by the computing device, a second grid corresponding to an event footprint, the second grid comprising cells, each cell having a coverage factor determined by the event footprint; and
applying, by the computing device, the second grid to the first grid in a convolution process to determine the risk exposure of each cell within the first grid.

2. The method of claim 1, wherein the convolution process is performed using discrete Fourier transforms or fast Fourier transforms.

3. The method of claim 1, wherein the points of interest correspond to insured locations.

4. The method of claim 1, wherein the event footprint corresponds to a catastrophic event.

5. The method of claim 1, wherein the first grid is modified to include an apron before the second grid is applied to the first grid in the convolution process.

6. The method of claim 1, wherein each cell's coverage factor comprises a ratio of its cell area that is covered by the event footprint.

7. The method of claim 1, wherein the second grid comprises a 3-by-3 array of cells.

8. The method of claim 1, wherein the convolution process comprises:
anchoring the second grid to a cell within the first grid;
multiplying the coverage factors within the second grid to the exposure total of respective cells within the first grid;
adding the products of the multiplying step to obtain a convolution result; and
assigning the convolution result to the anchored cell.

9. The method of claim 8, wherein said anchoring step to said assigning step are repeated for each cell in the first grid.

10. A system for determining risk exposure associated with points of interest, said system comprising:
a processor for generating a first grid comprising cells with exposure totals for points of interest within the cells, for generating a second grid corresponding to an event footprint, the second grid comprising cells, each cell having a coverage factor determined by the event footprint, and for applying the second grid to the first grid in a convolution process to determine the risk exposure of each cell within the first grid.

11. The system of claim 10, wherein the convolution process is performed using discrete Fourier transforms or fast Fourier transforms.

12. The system of claim 10, wherein the points of interest correspond to insured locations.

13. The system of claim 10, wherein the event footprint corresponds to a catastrophic event.

14. The system of claim 10, wherein the first grid is modified to include an apron before the second grid is applied to the first grid in the convolution process.

15. The system of claim 10, wherein each cell's coverage factor comprises a ratio of its cell area that is covered by the event footprint.

16. The system of claim 10, wherein the second grid comprises a 3-by-3 array of cells.

17. The system of claim 10, wherein the processor performs the convolution process by:
anchoring the second grid to a cell within the first grid;
multiplying the coverage factors within the second grid to the exposure total of respective cells within the first grid;
adding the products of the multiplying step to obtain a convolution result; and
assigning the convolution result to the anchored cell.

18. The system of claim 17, wherein the processor repeats said anchoring to said assigning for each cell in the first grid.
